(19) United States
(12) Patent Application Publication
(10) Pub. No.: US 2003/0177875 A1
(43) Pub. Date: Sep. 25, 2003

(54) Pipe pliers with auxiliary pressurizing mechanism

(76) Inventor: Tai-Her Yang, Si-Hu Town (TW)

Correspondence Address: RABIN & BERDO, P.C., Suite 500, 1101 14th Street, N.W., Washington, DC, 20005, US

(21) Appl. No.: 10/101,596

(22) Filed: Mar. 21, 2002

(51) Int. Cl. B25B 13/16

(52) U.S. Cl. 81/167

(57) ABSTRACT

An improved structure of a pair of pipe pliers with an auxiliary pressurizing mechanism, to drive both of a movable jaw at the inner side of a curved, movable block provided with a toothed section and a fixed jaw at the output of a handle to execute firmly holding a work object by pressurizing in opposite direction characterized by that the auxiliary pressurizing mechanism includes an additional auxiliary handle, or alternatively, a lateral adjusting screw structure to achieve the function by pressurizing to hold the work object.

### BACKGROUND OF THE INVENTION

(a) Field of the Invention

The present invention is related to a pair of pipe pliers with an auxiliary pressurizing mechanism, and more particularly, to one that allows relative pressurizing between a fixed jaw and a curved, movable jaw by means of a pressurizing structure.

(b) Description of the Prior Art

A conventional pair of pipe pliers operates by receiving insertion of a pipe work piece into a slightly inclined opening formed between a curved, movable, toothed jaw and a fixed, toothed jaw at the force output end of a handle, then the work piece is turned as desired. However, in practice, it usually requires several times of adjustment since it is difficult for the pliers to match the size of the work piece. Furthermore, it is also difficult for the pliers to clear off the workpiece after turning since the workpiece is held by the pliers by means of engagement at a certain inclination.

### SUMMARY OF THE INVENTION

The primary purpose of the present invention is to present a pair of pipe pliers with an auxiliary pressuring mechanism to force a relative pressuring to secure the work piece at where between the curved movable jaw and the fixed jaw at the force output end of the handle. The auxiliary pressurizing mechanism includes an additional auxiliary handle, or an additional laterally spiral force structure to achieve the purpose of pressurizing to secure the work piece.

### BRIEF DESCRIPTION OF THE DRAWINGS

FIG. 1 is a view of a first preferred embodiment of the present invention.

FIG. 2 is a sectional view of A-A′ taken from FIG. 1.

FIG. 3 is a sectional view of B-B′ taken from FIG. 1.

FIG. 4 is a view showing a second preferred embodiment of the present invention.

FIG. 5 is a sectional view of C-C′ taken from FIG. 4.

FIG. 6 is a view showing a third preferred embodiment of the present invention.

FIG. 7 is a sectional view of D-D′ taken from FIG. 6.

FIG. 8 is a fourth preferred embodiment of the present invention.

FIG.9 is a fifth preferred embodiment of the present invention.

FIG. 10 is a schematic view of a prior art.

### DETAILED DESCRIPTION OF THE PREFERRED EMBODIMENTS

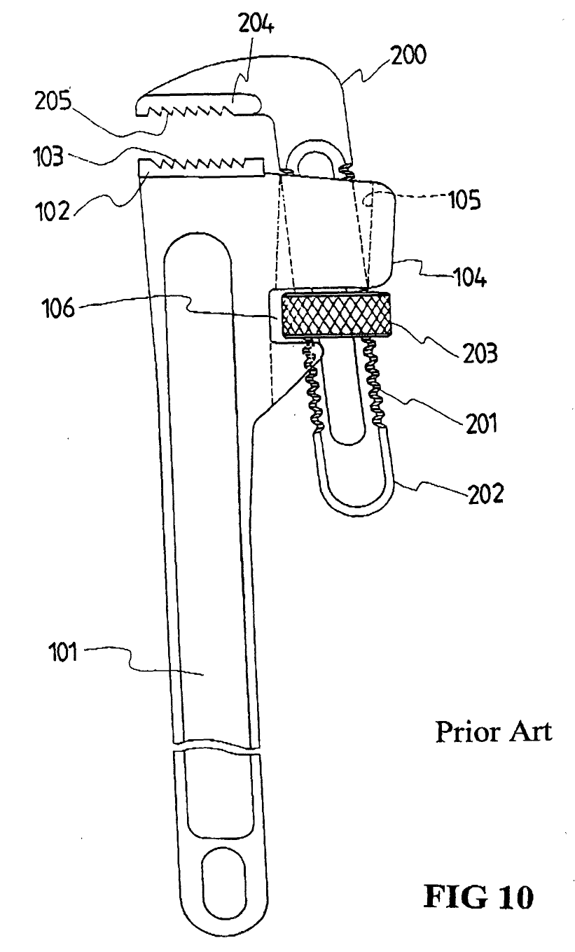

Referring to FIG. 10, the prior art of a pair of pipe pliers is essentially comprised of a handle 101 made of selected materials. One end of the handle 101 is for applying a force and the other end is the force output end and a fixed jaw 102 is extended from the force output end, the fixed jaw 102 is provided with a toothed structure 103. A channel holder 104 provided with an adjustable channel 105 is extended sideways from the output end of the handle 101. The adjustable channel 105 indicates an approximately square hole with its axis in parallel or approximately in parallel with the handle 101 to allow the insertion of an adjusting lever 202 provided with a toothed section 201 from a movable curved block 200, which is in its geometric shape to match that of the adjustable channel 105. Engagement of the adjustable channel 105 and the movable curved block 200 indicate loosely attachment fashion while an adjusting nut 203 is provided to the adjusting lever 202 to manipulate the adjusting lever 202 to execute relatively axial displacement for adjustment. By caulking the adjusting nut 203 to a limiting gap 106 provided to the channel holder 104, the curved, the adjusting lever 202 provided with the toothed section 201 of the movable block 200 is pushed as the adjusting nut turns, so that the fixed jaw 204 on the inner side of the curved, movable block 200 and the movable jaw 102 disposed at the output end of the handle 101 execute relative displacement for adjustment. The primary function is to form an opening that is with a larger outer portion and a smaller inner portion defined by the fixed jaw 102 and the movable jaw 204 that are loosely engaged to each other. The opening then receives and tightly compresses against a tube or a bar piece by the toothed jaws 102 and 204 to drive the work piece. However, the prior art is found with the following flaws:

1) Usually it takes several times before the opening to properly hold the work piece making manipulation less convenient, and even more difficult for non-professional user; and

2) Once the adjusting nut is turned, it prevents from continuous turning and a hammer may be used to knock off the work piece before turning the adjusting nut.

The present invention relates to a pair of pliers that is provided with an auxiliary pressurizing mechanism to eliminate those defectives found with the prior art by providing the pair of pliers an active holding feature by pressurizing, and is essentially comprised of:

1. A pressurizing mechanism made out of an active pressurizing handle in any of the following ways:

(1) The active pressurizing handle relates to an additional crank shaped handle structure with the crank shaped handle 301 indicating a curvature of a pre-selected angle, provided with a slip joint 303 and a return spring 305; the longer end being provided for an operator to actively compress against it and able to restore to its original position by means of the return spring 305; and its output end includes:

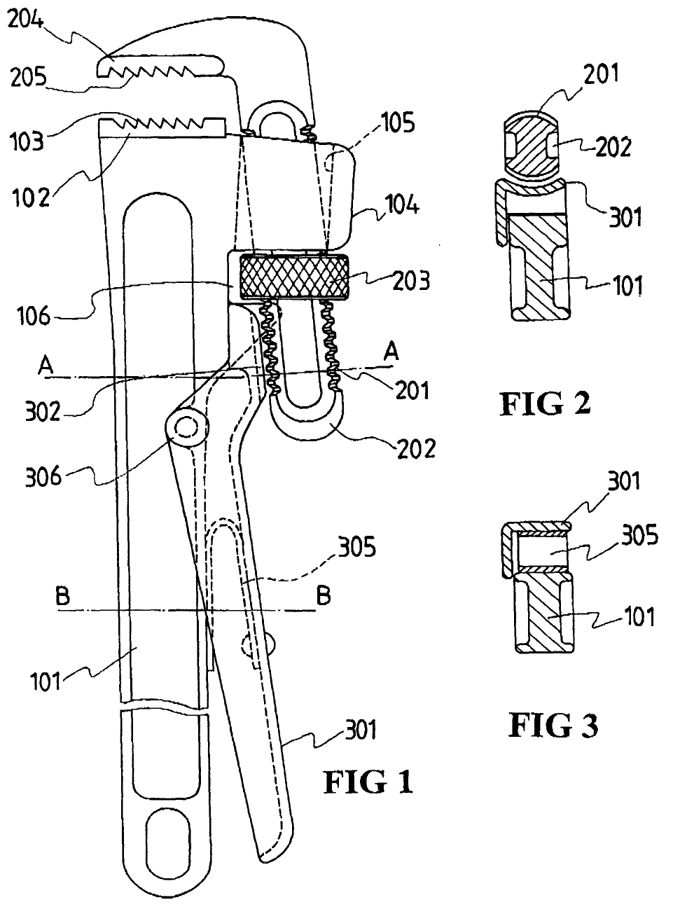

a) Referring to FIG. 1 for a first preferred embodiment of the present invention; FIG. 2, a sectional view of A-A′ taken from FIG. 1 and FIG. 3, a section view of B-B′ taken from Fig. 1. Within, the output end of the crank shaped handle 301 is made to indicate a curved press hammerhead structure 302; a joint 306 is provided at a middle section of the hammerhead structure 302 for coupling the hammerhead structure 302 to a middle section of the active pressurizing handle 101; thus for the active pressurizing handle 101 to force the holding side of the adjusting lever 202 of the curved moveable block 200 provided with a toothed section 201 that is closer to the active pressurizing handle 101; so that when the crank shaped handle 301 is pressed, it tightly compresses against the movable jaw 204 at the inner side of the curved, movable block 200 to execute relative pressurizing with the fixed jaw 102 at the output end of the active pressurizing handle 101 to hold a work piece;

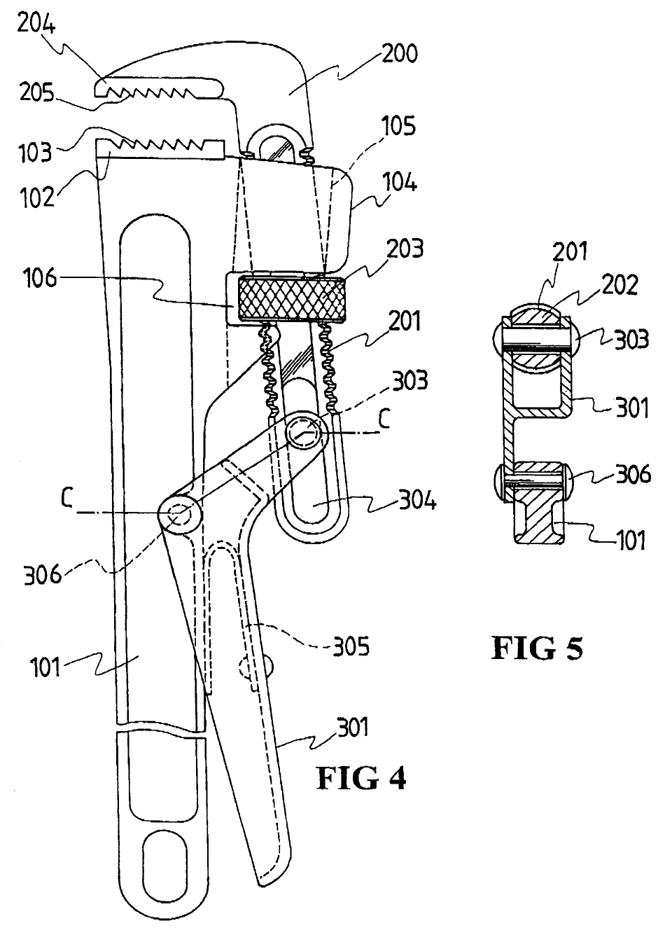

b) FIG. 4 shows a second preferred embodiment of the present invention and FIG. 5 shows a sectional view of C-C′ taken from FIG. 4. Wherein, the slip joint 303 is provided at the terminal of the output end of the crank shaped handle 301 so to slide to couple a longitudinal channel 304 in the end of the adjusting lever 202 provided with a tooth section 201 of the curved, movable block 200; so that both of the longitudinal channel 304 and the slip joint 303 are capable of completing effective matching during the adjusting course of the curved, movable block 200. A joint 306 is provided at a middle section of the crank shaped handle 301 for the crank shaped handle 301 to couple to a middles section of the active pressurizing handle 101 so that within the travel of the opening the crank shaped handle 301 is pressed to tightly compress against the movable jaw 204 at the inner side of the curved, movable block 200, thus to execute relative pressurizing jointly with the fixed jaw 102 of the active pressurizing handle 101 to hold the work object; or

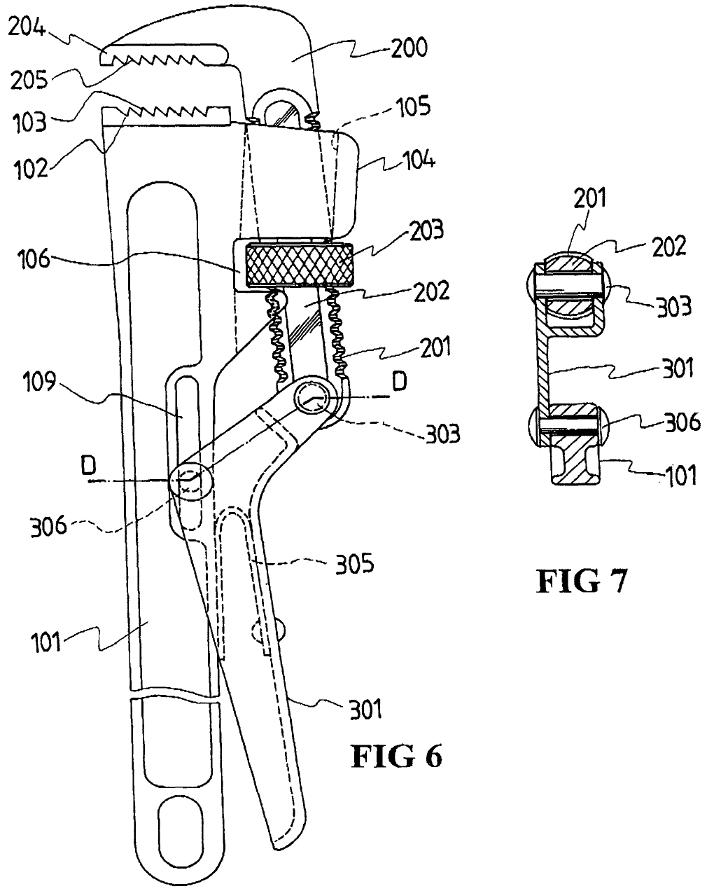

c) As illustrated in FIGS. 6 and 7 respectively showing a third preferred embodiment of the present invention and a sectional view of D-D′ taken from FIG. 6, the slip joint 303 is provided at the terminal of the output of the crank shaped handle 301 to engage to the terminal of the adjusting lever 202 provided with a tooth section of the curved, movable block 200. The joint 306 of the crank shaped handle 301 slides to couple to a longitudinal channel 109 provided in the active pressurizing handle 101, and the joint 306 also slides while the adjusting lever provided with a tooth section of the curved, movable block 200 is executing relative adjustment of position with the active pressurizing handle 101, so that when the crank shaped handle 301 is pressed, the movable jaw 204 at the inner side of the curved, movable block 200 is compressed to execute relative pressurizing jointly with the fixed jaw 102 of the active pressurizing handle 101 to hold the work object.

2. An active pressurizing structure is made by providing a pressurizing screw including:

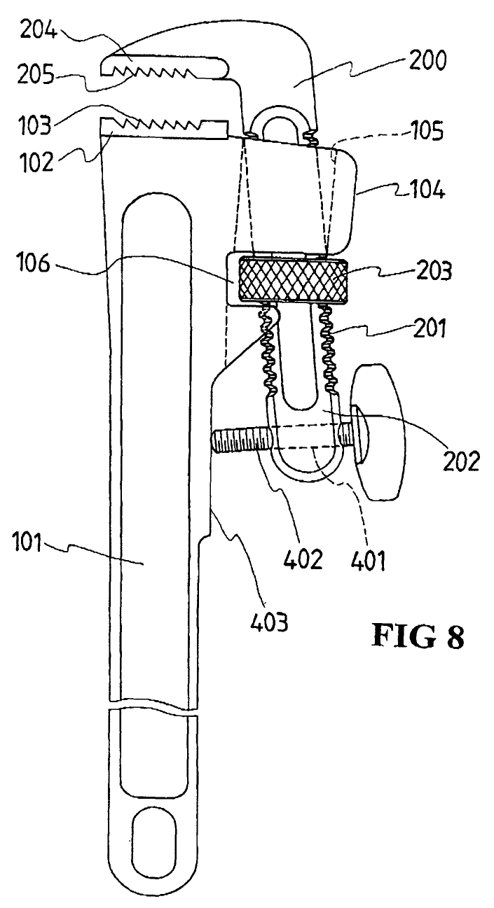

a) FIG. 8 shows a fourth preferred embodiment of the present invention. Wherein, a sideway screw hole 401 and a threaded rod 402 that can be turned to depress are provided at where the adjusting lever 202 provided with a toothed section 201 of the curved, movable block 200 is close to the side of the active pressurizing handle 101; a surface 403 subject to pressure is provided is provided on the active pressurizing handle 101 facing the adjusting lever 202 thus to form a pressurizing structure together with the threaded rod 402 that can be turned to depress disposed for the sideway screw hole 401 in the adjusting lever of the curved, movable block 200. By operating the threaded rod 402 to compress the surface 403 on the active pressurizing handle 101, the movable jaw 204 at the inner side of the curved, movable block 200 is compressed to execute relative pressurizing jointly with the fixed jaw 102 of the active pressurizing handle 101 to hold the work object;

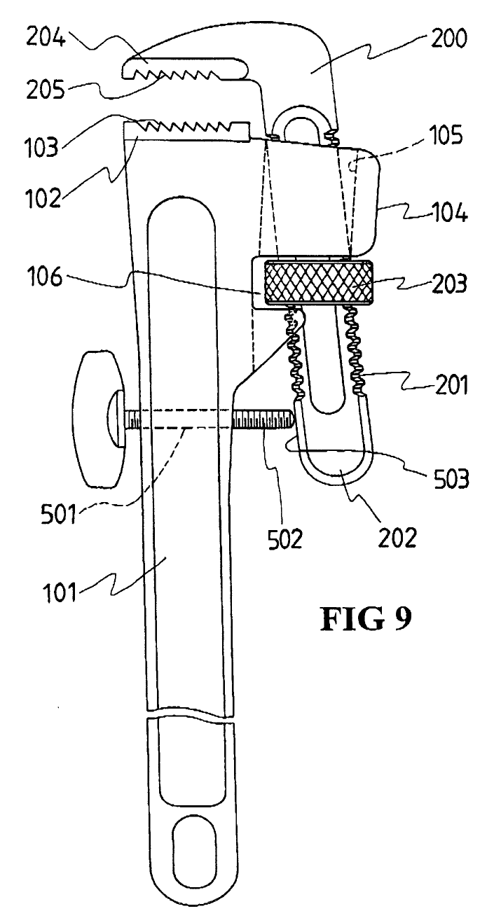

b) FIG. 9 shows a fifth preferred embodiment of the present invention. Within, a threaded rod 502 that can be turned to depress and a lateral screw hole 501 are provided in a middle section of the active pressurizing handle 101 to form a pressurizing structure together with a surface 503 disposed on the inner side of the adjusting lever 202 provided with the toothed section 201 of the curved, movable block 200 that is at where in relation to the active pressurizing handle 101. The pressurizing structure by operating the threaded rod 201 that can be turned to depress compresses the adjusting lever 202 provided with the toothed section 201 of the curved, movable block 200 and the surface 503 subject to pressure in relation to the active pressurizing handle 101 for the movable jaw 204 at the inner side of the curved, movable block 200 and the fixed jaw 102 of the active pressurizing handle 101 to execute relative pressurizing to hold the work object.

As disclosed, the present invention of an improved structure of a pair of pliers allowing easier holding and release motion than the prior art is found innovative in its concept of design and with precise functions. Therefore, this application for utility patent is duly filed accordingly.

I claim:

1. An improved structure of a pair of pipe pliers with an auxiliary pressurizing mechanism, to drive both of a movable jaw at the inner side of a curved, movable block provided with a toothed section and a fixed jaw at the output of a handle to execute firmly holding a work object by pressurizing in opposite direction characterized by that the auxiliary pressurizing mechanism includes an additional auxiliary handle, or alternatively, a lateral adjusting screw structure to achieve the function by pressurizing to hold the work object.

2. An improved structure of a pair of pipe pliers with an auxiliary pressurizing mechanism as claimed in claim 1, wherein, the improvement is essentially comprised of a pressurizing structure made of by an active pressurizing handle characterized by that:
The active pressurizing handle relates to an additional crank shaped handle structure with the crank shaped handle 301 indicating a curvature of a pre-selected angle, provided with a slip joint 303 and a return spring 305; the longer end being provided for an operator to actively compress against it and able to restore to its original position by means of the return spring 305.

3. An improved structure of a pair of pipe pliers with an auxiliary pressurizing mechanism as claimed in claim 2, wherein, the output end of the crank shaped handle 301 is made to indicate a curved press hammerhead structure 302; a joint 306 is provided at a middle section of the hammerhead structure 302 for coupling the hammerhead structure 302 to a middle section of the active pressurizing handle 101; thus for the active pressurizing handle 101 to force the holding side of the adjusting lever 202 of the curved moveable block 200 provided with a toothed section 201 that is closer to the active pressurizing handle 101; so that when the crank shaped handle 301 is pressed, it tightly compresses against the movable jaw 204 at the inner side of the curved, movable block 200 to execute relative pressurizing with the fixed jaw 102 at the output end of the active pressurizing handle 101 to hold a work piece.

4. An improved structure of a pair of pipe pliers with an auxiliary pressurizing mechanism as claimed in claim 2, wherein, a slip joint 303 is provided at the terminal of the output end of the crank shaped handle 301 so to slide to couple a longitudinal channel 304 in the end of the adjusting lever 202 provided with a tooth section 201 of the curved, movable block 200; so that both of the longitudinal channel 304 and the slip joint 303 are capable of completing effective matching during the adjusting course of the curved, movable block 200; a joint 306 is provided at a middle section of the crank shaped handle 301 for the crank shaped handle 301 to couple to a middles section of the active pressurizing handle 101 so that within the travel of the opening the crank shaped handle 301 is pressed to tightly compress against the movable jaw 204 at the inner side of the curved, movable block 200, thus to execute relative pressurizing jointly with the fixed jaw 102 of the active pressurizing handle 101 to hold the work object.

5. An improved structure of a pair of pipe pliers with an auxiliary pressurizing mechanism as claimed in claim 2, wherein, the slip joint 303 is provided at the terminal of the output of the crank shaped handle 301 to engage to the terminal of the adjusting lever 202 provided with a tooth section of the curved, movable block 200. The joint 306 of the crank shaped handle 301 slides to couple to a longitudinal channel 109 provided in the active pressurizing handle 101, and the joint 306 also slides while the adjusting lever provided with a tooth section of the curved, movable block 200 is executing relative adjustment of position with the active pressurizing handle 101, so that when the crank shaped handle 301 is pressed, the movable jaw 204 at the inner side of the curved, movable block 200 is compressed to execute relative pressurizing jointly with the fixed jaw 102 of the active pressurizing handle 101 to hold the work object.

6. An improved structure of a pair of pipe pliers with an auxiliary pressurizing mechanism as claimed in claim 1, wherein, a active pressurizing structure is made by providing a pressurizing screw including characterized by that: a sideway screw hole 401 and a threaded rod 402 that can be turned to depress are provided at where the adjusting lever 202 provided with a toothed section 201 of the curved, movable block 200 is close to the side of the active pressurizing handle 101; a surface 403 subject to pressure is provided is provided on the active pressurizing handle 101 facing the adjusting lever 202 thus to form a pressurizing structure together with the threaded rod 402 that can be turned to depress disposed for the sideway screw hole 401 in the adjusting lever of the curved, movable block 200; and by operating the threaded rod 402 to compress the surface 403 on the active pressurizing handle 101, the movable jaw 204 at the inner side of the curved, movable block 200 is compressed to execute relative pressurizing jointly with the fixed jaw 102 of the active pressurizing handle 101 to hold the work object.

7. An improved structure of a pair of pipe pliers with an auxiliary pressurizing mechanism as claimed in claim 1, wherein, an active pressurizing structure is made by a pressurizing screw characterized by that a threaded rod 502 that can be turned to depress and a lateral screw hole 501 are provided in a middle section of the active pressurizing handle 101 to form a pressurizing structure together with a surface 503 disposed on the inner side of the adjusting lever 202 provided with the toothed section 201 of the curved, movable block 200 that is at wherein relation to the active pressurizing handle 101; and the pressurizing structure by operating the threaded rod 201 that can be turned to depress compresses the adjusting lever 202 provided with the toothed section 201 of the curved, movable block 200 and the surface 503 subject to pressure in relation to the active pressurizing handle 101 for the movable jaw 204 at the inner side of the curved, movable block 200 and the fixed jaw 102 of the active pressurizing handle 101 to execute relative pressurizing to hold the work object.
